(19) United States
(12) Patent Application Publication
(10) Pub. No.: US 2026/0147217 A1
(43) Pub. Date: May 28, 2026

(54) WEARABLE ELECTRONIC DEVICE COMPRISING LENS ASSEMBLY

(71) Applicant: SAMSUNG ELECTRONICS CO., LTD., Suwon-si (KR)

(72) Inventors: Hongsuk KIM, Suwon-si (KR); Soonsang PARK, Suwon-si (KR); Byungkwon KANG, Suwon-si (KR); Hyunsoo KIM, Suwon-si (KR); Chanhyung YOO, Suwon-si (KR); Kwangtai KIM, Suwon-si (KR); Dongchoon HWANG, Suwon-si (KR)

(73) Assignee: SAMSUNG ELECTRONICS CO., LTD., Suwon-si (KR)

(21) Appl. No.: 19/456,320

(22) Filed: Jan. 22, 2026

Related U.S. Application Data
(63) Continuation of application No. PCT/KR2024/010719, filed on Jul. 24, 2024.

(30) Foreign Application Priority Data
Jul. 24, 2023 (KR) 10-2023-0096210
Nov. 14, 2023 (KR) 10-2023-0157567

(51) Int. Cl. G02B 27/01; G02B 7/02; G02B 7/10

(52) U.S. Cl. CPC G02B 27/0176; G02B 7/021; G02B 7/023; G02B 7/102; G02B 2027/014; G02B 2027/0154; G02B 2027/0163; G02B 2027/0169; G02B 2027/0178

(57) ABSTRACT

An electronic device includes a housing; a printed circuit board in the housing; a lens assembly configured to be movable in a first direction or a second direction opposite to the first direction, the lens assembly including a first lens, the first lens being a liquid crystal (LC) lens; a first barrel surrounding the lens assembly, the first barrel being configured to adjust a position of the lens assembly, and including a first thread, at least a portion of the first thread is metal; a second barrel surrounding the first barrel, the second barrel including a second thread, at least a portion of the second thread is metal; a plurality of metal lines positioned inside the second barrel; and a processor electrically connected to the printed circuit board and configured to control a refractive index of the first lens based on a sensor value received from a sensor member.

### CROSS-REFERENCE TO RELATED APPLICATIONS

This application is a continuation of International Application No. PCT/KR2024/010719, filed on Jul. 24, 2024, which is based on and claims priority to Korean Patent Application No. 10-2023-0096210, filed on Jul. 24, 2023, and Korean Patent Application No. 10-2023-0157567, filed on Nov. 14, 2023, in the Korean Intellectual Property Office, the disclosures of which are incorporated by reference herein in their entireties.

### BACKGROUND

### 1. Field

The disclosure relates to a wearable electronic device including a lens assembly.

### 2. Description of Related Art

Portable electronic devices, such as electronic schedulers, portable multimedia players, mobile communication terminals, tablet personal computers (PCs), etc., are generally equipped with a display member and a battery, and may be limited in shape to a bar, clamshell, or slidable shape by their accompanying displays or batteries. As display members and batteries are nowadays made smaller and have enhanced performance, electronic devices (hereinafter, ‘wearable electronic devices’) which may be put on the user's wrist, head, or other body portions are appearing.

Examples of wearable electronic devices include head-mounted wearable devices (HMD), smart glasses, smart watches (or bands), contact lens-type devices, ring-type devices, clothing/shoes/glove-type devices, and the like. Such body-worn electronic devices are easy to carry and may enhance user accessibility.

As an example, a ‘head-mounted wearable device’ is a device worn on the user's head or face, and is a device that projects an image onto the user's retina to view a virtual image in a three-dimensional space. For example, head-mounted wearable devices may be divided into a see-through type that provides augmented reality (AR) and a see-closed type that provides virtual reality (VR). The see-through type head mounted wearable device may be implemented in the form of glasses and may provide the user with, e.g., information, such as buildings and objects in the space within the user's field of view, in the form of images or text. The see-closed type head-mounted wearable device may output independent images to the user's eyes, respectively, and provide the user with content (games, movies, streaming, broadcasting, etc.), which is provided from a mobile communication terminal or an external input, in the form of video or sound to thereby provide an excellent sense of immersion. Further, the head-mounted wearable device may be used to provide mixed reality (MR) or extended reality (XR), which is a combination of augmented reality (AR) and virtual reality (VR).

Recently, development of products related to head-mounted wearable devices is actively progressing. Head-mounted wearable devices are used for various purposes, such as military, gaming, industrial, and medical use. Accordingly, it is required to provide good image quality while in a lighter and smaller size.

The above-described information may be provided as related art for the purpose of helping understanding of the disclosure. No claim or determination is made as to whether any of the foregoing is applicable as background art in relation to the disclosure.

### SUMMARY

According to an aspect of the disclosure, an electronic device includes a housing; a printed circuit board disposed within the housing; a lens assembly configured to be movable in a first direction or a second direction opposite to the first direction, the lens assembly including a first lens, the first lens being a liquid crystal (LC) lens; a first barrel surrounding the lens assembly, the first barrel being configured to adjust a position of the lens assembly, and including a first thread, at least a portion of the first thread is metal; a second barrel surrounding the first barrel, the second barrel including a second thread, at least a portion of the second thread is metal; a plurality of metal lines positioned inside the second barrel; and a processor electrically connected to the printed circuit board and configured to control a refractive index of the first lens based on a sensor value received from a sensor member. The plurality of metal lines includes a first metal line electrically connected to the printed circuit board; a second metal line electrically connected to the sensor member, the sensor member is fixed to the first barrel; and a third metal line electrically connected to the first lens, and the third metal line comprises at least one partial region configured to electrically connect to either the first metal line or the second metal line according to a rotation of the first barrel.

The second thread may include at least one partial region configured to contact the third metal line, and the at least one partial region of the third metal line contacts the printed circuit board.

The first barrel may be movable, and the second barrel may be fixed in position.

The first barrel may include a 1-1th surface surrounding at least one of the first lens, a 1-2th surface perpendicularly contacting the 1-1th surface and facing a third direction, the third direction being toward a center of the first barrel, and a 1-3th surface perpendicularly contacting the 1-1th surface and facing a fourth direction, the fourth direction being opposite to the third direction.

The second barrel may include a 2-1th surface surrounding a second lens, a 2-2th surface perpendicularly contacting the 2-1th surface and facing the third direction, and a 2-3th surface perpendicularly contacting the 2-1th surface and facing the fourth direction.

The first lens may be fixed to the first barrel. The lens assembly further includes a second lens fixed to the second barrel, and based on the first barrel moving, a distance between the first lens and the second lens may be adjusted.

The first thread may be disposed on the 1-3th surface, and the second thread may be disposed on the 2-2th surface.

A surface of the first thread and a surface of the second thread may contact each other.

The 1-3th surface may include a groove recessed in the third direction. The sensor member is disposed in the groove.

The second barrel may include a plurality of holes recessed in a rear direction from the 2-1th surface. The plurality of metal lines may be disposed within the plurality of holes.

A surface of the first metal line may be exposed to an outside of the second barrel.

A surface of the first metal line may contact the second thread.

The sensor member may include a plurality of metal legs configured to contact the first thread.

The sensor member may include a plurality of metal legs configured to contact the second thread.

The second metal line may contact the second thread.

The first lens may contact the first thread, and the third metal line may contact the second thread.

The second barrel may include a 2-1th surface surrounding a second lens; a 2-2th surface perpendicularly contacting the 2-1th surface and facing a third direction, the third direction being toward a center of the second barrel; and a 2-3th surface perpendicularly contacting the 2-1th surface and facing a fourth direction, the fourth direction being opposite to the third direction.

The sensor member may be an Inertial Measurement Unit (IMU), and may be configured to measure a rotational speed of the first barrel.

According to an aspect of the disclosure, an electronic device includes a housing; a printed circuit board disposed within the housing; a lens assembly configured to be movable in a first direction or a second direction opposite to the first direction, the lens assembly including a first lens, the first lens being a liquid crystal (LC) lens; a first barrel surrounding the lens assembly, the first barrel being configured to adjust a position of the lens assembly, and including a first thread, at least a portion of the first thread is metal, a 1-1th surface surrounding at least one of the first lens; a 1-2th surface perpendicularly contacting the 1-1th surface and facing a third direction, the third direction being toward a center of the first barrel; and a 1-3th surface perpendicularly contacting the 1-1th surface and facing a fourth direction, the fourth direction being opposite to the third direction; a second barrel surrounding the first barrel, the second barrel including a second thread, at least a portion of the second thread is metal; and a processor electrically connected to the printed circuit board and configured to control a refractive index of the first lens based on a sensor value received from a sensor member.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a block diagram illustrating an electronic device in a network environment according to an embodiment of the disclosure;

FIG. 2 is a perspective view illustrating a wearable electronic device according to an embodiment of the disclosure;

FIG. 3 is an assembled perspective view illustrating an internal configuration of a wearable electronic device according to an embodiment of the disclosure;

FIG. 4 is an exploded perspective view illustrating a wearable electronic device according to an embodiment of the disclosure;

FIG. 5A is a front view illustrating a wearable electronic device according to an embodiment of the disclosure;

FIG. 5B is a rear view illustrating a wearable electronic device according to an embodiment of the disclosure;

FIG. 6A is a view schematically illustrating a cross-section of the wearable electronic device of FIG. 5B taken along line A-A′ according to an embodiment of the disclosure;

FIG. 6B is a view schematically illustrating a wearable electronic device including a motor according to an embodiment of the disclosure;

FIG. 7 is a view illustrating a barrel including a thread according to an embodiment of the disclosure;

FIG. 8 is a side view illustrating a first thread of a first barrel according to an embodiment of the disclosure;

FIG. 9 is a side view illustrating a second thread of a second barrel according to an embodiment of the disclosure;

FIG. 10 is a side view illustrating first and second threads of first and second barrels according to an embodiment of the disclosure;

FIG. 11 is a view of first and second threads of first and second barrels from a front direction according to an embodiment of the disclosure;

FIG. 12 is a view illustrating a barrel including a sensor member from a side according to an embodiment of the disclosure;

FIG. 13 is a view illustrating a barrel including a sensor member from a front according to an embodiment of the disclosure;

FIG. 14 is a view illustrating a barrel including a plurality of metal lines from a front according to an embodiment of the disclosure;

FIG. 15 is a view illustrating a sensor member according to an embodiment of the disclosure; and

FIG. 16 is a view illustrating a connection relationship between a sensor member and a barrel according to an embodiment of the disclosure.

### DETAILED DESCRIPTION

The electronic device according to embodiments of the disclosure may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

An embodiment of the disclosure and terms used therein are not intended to limit the technical features described in the disclosure to specific embodiments, and should be understood to include various modifications, equivalents, or substitutes of the embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

According to an embodiment, each component (e.g., a module or a program) of the above-described components may include a single entity or multiple entities. Some of the plurality of entities may be separately disposed in different components. According to an embodiment, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

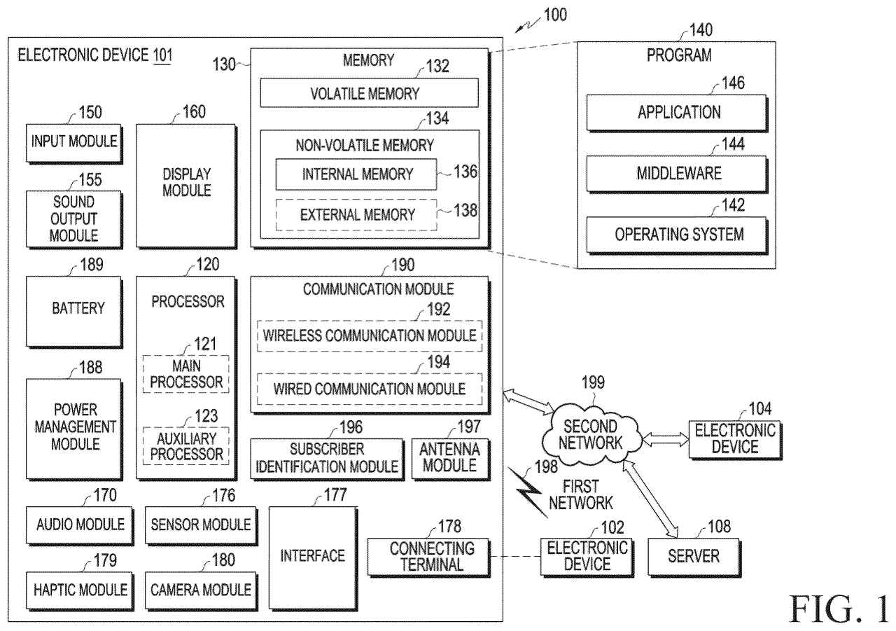

FIG. 1 is a block diagram illustrating an electronic device in a network environment according to an embodiment of the disclosure;

Referring to FIG. 1, the electronic device 101 in the network environment 100 may communicate with an electronic device 102 via a first network 198 (e.g., a short-range wireless communication network), or an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In an embodiment, at least one (e.g., the connecting terminal 178) of the components may be omitted from the electronic device 101, or one or more other components may be added in the electronic device 101. In an embodiment, some (e.g., the sensor module 176, the camera module 180, or the antenna module 197) of the components may be integrated into a single component (e.g., the display module 160).

The processor 120 may execute, for example, software (e.g., the program 140) to control at least one other component (e.g., a hardware or software component) of the electronic device 101 coupled with the processor 120, and may perform various data processing or computation. According to one embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be configured to use lower power than the main processor 121 or to be specified for a designated function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. The artificial intelligence model may be generated via machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by other component (e.g., the processor 120) of the electronic device 101, from the outside (e.g., a user) of the electronic device 101. The input module 150 may include, for example, a microphone, a mouse, a keyboard, keys (e.g., buttons), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor configured to detect a touch, or a pressure sensor configured to measure the intensity of a force generated by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operation state (e.g., power or temperature) of the electronic device 101 or an external environmental state (e.g., the user's state), and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or motion) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wiredly) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device 104 via a first network 198 (e.g., a short-range communication network, such as Bluetooth™, wireless-fidelity (Wi-Fi) direct, or infrared data association (IrDA)) or a second network 199 (e.g., a long-range communication network, such as a legacy cellular network, a 5G network, a next-generation communication network, the Internet, or a computer network (e.g., local area network (LAN) or wide area network (WAN)). These various types of communication modules may be implemented as a single component (e.g., a single chip), or may be implemented as multi components (e.g., multi chips) separate from each other. The wireless communication module 192 may identify or authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device). According to an embodiment, the antenna module 197 may include one antenna including a radiator formed of a conductor or conductive pattern formed on a substrate (e.g., a printed circuit board (PCB)). According to an embodiment, the antenna module 197 may include a plurality of antennas (e.g., an antenna array). In this case, at least one antenna appropriate for a communication scheme used in a communication network, such as the first network 198 or the second network 199, may be selected from the plurality of antennas by, e.g., the communication module 190. The signal or the power may then be transmitted or received between the communication module 190 and the external electronic device via the selected at least one antenna. According to an embodiment, other parts (e.g., radio frequency integrated circuit (RFIC)) than the radiator may be further formed as part of the antenna module 197.

According to an embodiment, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, instructions or data may be transmitted or received between the electronic device 101 and the external electronic device 104 via the server 108 coupled with the second network 199. The external electronic devices 102 or 104 each may be a device of the same or a different type from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In an embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

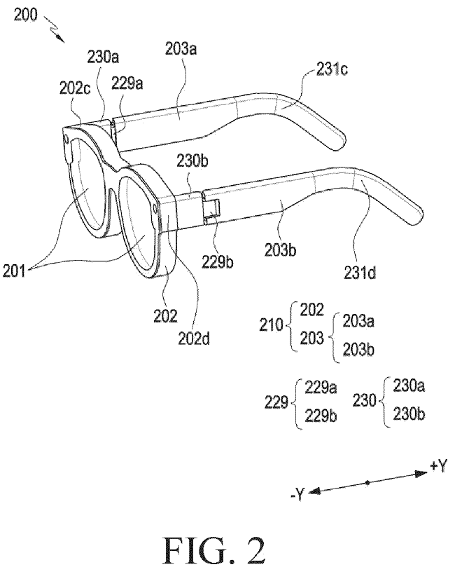

FIG. 2 is an exploded perspective view illustrating a wearable electronic device 200 according to an embodiment of the disclosure.

Referring to FIG. 2, the wearable electronic device 200 may be a glasses-type electronic device (e.g., the electronic device 101 of FIG. 1), and the user may visually recognize the surrounding objects or environment while wearing the wearable electronic device 200. For example, the wearable electronic device 200 may include a head-mounted device (HMD) or smart glasses capable of providing images directly in front of the user's eyes. The configuration of the wearable electronic device 200 of FIG. 2 may be identical in whole or part to the configuration of the electronic device 101 of FIG. 1.

According to an embodiment, the wearable electronic device 200 may include a housing that forms the exterior of the wearable electronic device 200. The housing 210 may provide a space in which components of the wearable electronic device 200 may be disposed. For example, the housing 210 may include a lens frame 202 and at least one wearing member 203.

According to an embodiment, the wearable electronic device 200 may include at least one display member 201 disposed in the housing 210 and capable of outputting a visual image. For example, the wearable electronic device 200 may include at least one display member 201 capable of providing the user with visual information (or images). For example, the display member 201 may include a module equipped with a lens, a display, a waveguide, and/or a touch circuit. According to an embodiment, the display member 201 may be transparent or semi-transparent. According to an embodiment, the display member 201 may include a semi-transparent glass or a window member the light transmittance of which may be adjusted as the coloring concentration is adjusted.

According to an embodiment, the lens frame 202 may receive at least a portion of the display member 201. For example, the lens frame 202 may surround at least a portion of the display member 201. According to an embodiment, the lens frame 202 may position at least one of the display members 201 to correspond to the user's eye. According to an embodiment, the lens frame 202 may be the rim of a normal eyeglass structure. According to an embodiment, the lens frame 202 may include at least one closed loop surrounding the display member 201. According to an embodiment, the lens frame 202 may include a first end 202c and a second end 202d opposite to the first end 202c. The first end 202c may be disposed adjacent to the first wearing member 203a, and the second end 202d may be disposed adjacent to the second wearing member 203b.

According to an embodiment, the wearing members 203 may extend from the lens frame 202. For example, the wearing members 203 may extend from ends of the lens frame 202 and, together with the lens frame 202, may be supported and/or positioned on a part (e.g., ears) of the user's body. According to an embodiment, the wearing members 203 may be rotatably coupled to the lens frame 202 through hinge structures 229. According to an embodiment, the wearing member 203 may include an inner side surface 231c configured to face the user's body and an outer side surface 231d opposite to the inner side surface 231c. According to an embodiment (not shown), at least a portion of the wearing member 203 may be formed of a flexible material (e.g., rubber). For example, at least a portion of the wearing member 203 may be formed in a band shape surrounding at least a portion of the user's body (e.g., ears).

According to an embodiment, the wearable electronic device 200 may include the hinge structures 229 configured to fold the wearing members 203 on the lens frame 202. The hinge structure 229 may be disposed between the lens frame 202 and the wearing member 203. While the user does not wear the wearable electronic device 200, the user may fold the wearing members 203 on the lens frame 202 to carry or store the electronic device. According to an embodiment, the hinge structure 229 may include a first hinge structure 229a connected to a portion (e.g., the first end 202c) of the lens frame 202 and the first wearing member 203a and a second hinge structure 229b connected to a portion (e.g., the second end 202d) of the lens frame 202 and the second wearing member 203b.

According to an embodiment, the first hinge structure 229a and the second hinge structure 229b may be positioned to be spaced apart from the display member 201 by a predetermined distance in the Y-axis direction. A hinge connection structure 230 may include a first hinge connection structure 230a and a second hinge connection structure 230b. The first hinge structure 229a may be fixed to the lens frame 202 by the first hinge connection structure 230a, and the second hinge structure 229b may be fixed to the lens frame 202 by the second hinge connection structure 230b.

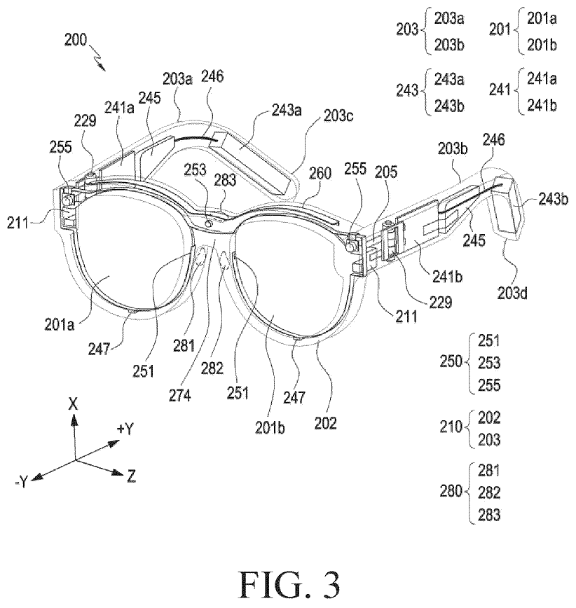

FIG. 3 is an assembled perspective view illustrating an internal configuration of a wearable electronic device 200 according to an embodiment of the disclosure.

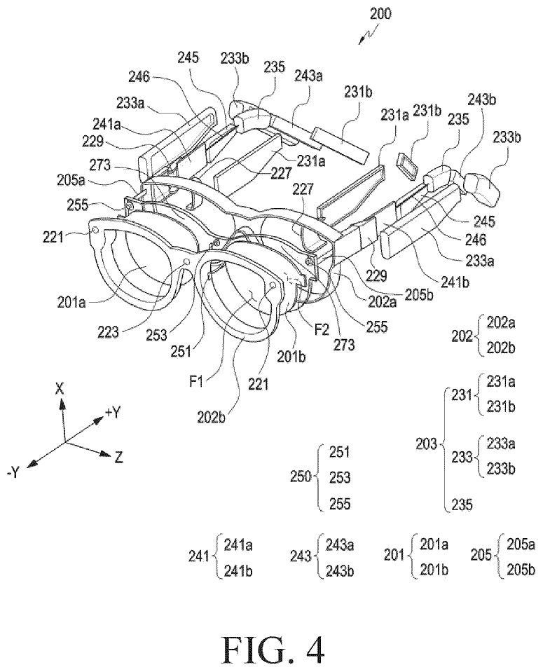

FIG. 4 is an exploded perspective view illustrating a wearable electronic device 200 according to an embodiment of the disclosure.

The configuration of the display member 201, the lens frame 202, the wearing member 203, and the hinge structure 229 of FIGS. 3 and/or 4 may be identical in whole or part to the configuration of the display member 201, the lens frame 202, the wearing member 203, and the hinge structure 229 of FIG. 2.

Referring to FIGS. 3 and 4, the wearable electronic device 200 may include at least one display member 201, a lens frame 202, at least one wearing member 203, at least one hinge structure 229, at least one circuit board 241, at least one battery 243, at least one power transfer structure 246, at least one camera module 250, and/or at least one sensor module 280.

According to an embodiment, the wearable electronic device 200 may obtain and/or recognize a visual image regarding an object or environment in the direction (e.g., −Y direction) in which the electronic device 200 faces or the direction in which the user gazes, using the camera module 250 (e.g., the camera module 180 of FIG. 1) and may receive information regarding the object or environment from an external electronic device (e.g., the electronic device 102 or 104 of FIG. 1 or the server 108 of FIG. 1) through a network (e.g., the first network 198 or second network 199 of FIG. 1). In an embodiment, the wearable electronic device 200 may provide the received object- or environment-related information, in the form of an audio or visual form, to the user. The wearable electronic device 200 may provide the received object- or environment-related information, in a visual form, to the user through the display members 201, using the display module (e.g., the display module 160 of FIG. 1). For example, the wearable electronic device 200 may implement augmented reality (AR) by implementing the object- or environment-related information in a visual form and combining it with an actual image of the user's surrounding environment.

According to an embodiment, a pair of display members 201 may be provided and disposed to correspond to the user's left and right eyes, respectively, with the wearable electronic device 200 worn on the user's body. For example, the display member 201 may include a first display member 201a and a second display member 201b disposed to be spaced apart from the first display member 201a. The first display member 201a may be disposed to correspond to the user's right eye, and the second display member 201b may be disposed to correspond to the user's left eye.

According to an embodiment, the display member 201 may include a first surface F1 facing in a direction (e.g., −y direction) in which external light is incident and a second surface F2 facing in a direction (e.g., +y direction) opposite to the first surface F1. With the user wearing the wearable electronic device 200, at least a portion of the light or image coming through the first surface F1 may be incident on the user's left eye and/or right eye through the second surface F2 of the display member 201 disposed to face the user's left eye and/or right eye.

According to an embodiment, the lens frame 202 may include at least two or more frames. For example, the lens frame 202 may include a first frame 202a and a second frame 202b. According to an embodiment, when the user wears the wearable electronic device 200, the first frame 202a may be a frame of the portion facing the user's face, and the second frame 202b may be a portion of the lens frame 202 spaced from the first frame 202a in the gazing direction (e.g., −Y direction) in which the user gazes.

According to an embodiment, the electronic device 200 may include at least one light output module 211 configured to provide an image and/or video to the user. For example, the light output module 211 may include a display panel (not shown) capable of outputting images and a lens (not shown) corresponding to the user's eye and guiding images to the display member 201. For example, the user may obtain the image output from the display panel of the light output module 211 through the lens of the light output module 211. According to various embodiments, the light output module 211 may include a device configured to display various information. For example, the light output module 211 may include at least one of a liquid crystal display (LCD), a digital mirror device (DMD), a liquid crystal on silicon (LCoS), a light emitting diode (LED on silicon (LEDoS), an organic light emitting diode (OLED), or a micro light emitting diode (micro LED). According to an embodiment, when the light output module 211 and/or the display member 201 includes one of a liquid crystal display device, a digital mirror display device, or a silicon liquid crystal display device, the wearable electronic device 200 may include a light output module 211 and/or a light source emitting light to the display area of the display member 201. According to an embodiment, when the light output module 211 and/or the display member 201 includes organic light emitting diodes or micro LEDs, the wearable electronic device 200 may provide virtual images to the user without a separate light source.

According to an embodiment, at least a portion of the light output module 211 may be disposed in the housing 210. For example, the light output module 211 may be connected to the display member 201 and may provide images to the user through the display member 201. For example, the image output from the light output module 211 may be incident on the display member 201 through an input optical member (not shown) positioned at an end of the display member 201 and be radiated to the user's eyes through a waveguide (not shown) and an output optical member (not shown) positioned in at least a portion of the display member 201.

According to an embodiment, the wearable electronic device 200 may include a circuit board 241 (e.g., a printed circuit board (PCB), a printed board assembly (PBA), a flexible PCB (FPCB), or a rigid-flexible PCB (RFPCB)) receiving components for driving the wearable electronic device 200. For example, the circuit board 241 may include at least one integrated circuit chip, and at least one of a processor (not shown) (e.g., the processor 120 of FIG. 1), memory (not shown) (e.g., the memory 130 of FIG. 1), a power management module (not shown) (e.g., the power management module 188 of FIG. 1), or a communication module (e.g., the communication module 190 of FIG. 1) may be provided in the integrated circuit chip. According to an embodiment, the circuit board 241 may be disposed in the wearing member 203 of the housing 210. For example, the circuit board 241 may include a first circuit board 241a disposed in the first wearing member 203a and a second circuit board 241b disposed in the second wearing member 203b. According to an embodiment, the communication module (e.g., the communication module 190 of FIG. 1) may be disposed on the first circuit board 241a positioned in the first wearing member 203a, and the processor (e.g., the processor 120 of FIG. 1) may be disposed on the second circuit board 241b positioned in the second wearing member 203b. According to an embodiment, the circuit board 241 may be electrically connected to the battery 243 (e.g., the battery 189 of FIG. 1) through the power transfer structure 246. According to an embodiment, the circuit board 241 may be an interposer board.

According to an embodiment, the battery 243 may be connected with components (e.g., the light output module 211, the circuit board 241, and the speaker module 245, the microphone module 247, and/or the camera module 250) of the wearable electronic device 200 and may supply power to the components of the wearable electronic device 200.

According to an embodiment, at least a portion of the battery 243 may be disposed in the wearing member 203. According to an embodiment, the battery 243 may include a first battery 243a disposed in the first wearing member 203a and a second battery 243b disposed in the second wearing member 203b. According to an embodiment, batteries 243 may be disposed adjacent to ends 203c and 203d of the wearing members 203.

According to an embodiment, the speaker module 245 (e.g., the audio module 170 or the sound output module 155 of FIG. 1) may convert an electrical signal into sound. At least a portion of the speaker module 245 may be disposed in the wearing member 203 of the housing 210. According to an embodiment, the speaker module 245 may be located in the wearing member 203 to correspond to the user's ear. According to an embodiment (e.g., FIG. 3), the speaker module 245 may be disposed next to the circuit board 241. For example, the speaker module 245 may be disposed between the circuit board 241 and the battery 243. According to an embodiment (not shown), the speaker module 245 may be disposed on the circuit board 241. For example, the speaker module 245 may be disposed between the circuit board 241 and the inner case (e.g., the inner case 231 of FIG. 4).

According to an embodiment, the wearable electronic device 200 may include a power transfer structure 246 configured to transfer power from the battery 243 to an electronic component (e.g., the light output module 211) of the wearable electronic device 200. For example, the power transfer structure 246 may be electrically connected to the battery 243 and/or the circuit board 241, and the circuit board 241 may transfer the received power to the light output module 211 through the power transfer structure 246. According to an embodiment, the power transfer structure 246 may be a component capable of transferring power. For example, the power transfer structure 246 may include a flexible printed circuit board or wiring. For example, the wiring may include a plurality of cables (not shown). In various embodiments, various changes may be made to the shape of the power transfer structure 246 considering the number and/or type of the cables.

According to an embodiment, the microphone module 247 (e.g., the input module 150 and/or the audio module 170 of FIG. 1) may convert a sound into an electrical signal. According to an embodiment, the microphone module 247 may be disposed in the lens frame 202. For example, at least one microphone module 247 may be disposed on a lower end (e.g., in the-X-axis direction) and/or on an upper end (e.g., in the +X-axis direction) of the wearable electronic device 200. According to an embodiment, the wearable electronic device 200 may more clearly recognize the user's voice using voice information (e.g., sound) obtained by the at least one microphone module 247. For example, the electronic device 200 may distinguish the voice information from the ambient noise based on the obtained voice information and/or additional information (e.g., low-frequency vibration of the user's skin and bones). For example, the wearable electronic device 200 may clearly recognize the user's voice and may perform a function of reducing ambient noise (e.g., noise canceling).

According to an embodiment, the camera module 250 may capture a still image and/or a video. The camera module 250 may include at least one of a lens, at least one image sensor, an image signal processor, or a flash. According to an embodiment, the camera module 250 may be disposed in the lens frame 202 and may be disposed around the display member 201.

According to an embodiment, the camera module 250 may include at least one first camera module 251. According to an embodiment, the first camera module 251 may capture the trajectory of the user's eye (e.g., a pupil) or gaze. For example, the first camera module 251 may include a light emitting unit (e.g., an IR LED) (not shown) configured to emit light in an infrared band and a camera structure (not shown) configured to capture the reflection pattern of the light emitted by the light emitting unit to the user's eyes. According to an embodiment, the processor (e.g., the processor 120 of FIG. 1) may adjust the position of the virtual image so that the virtual image projected on the display member 201 corresponds to the direction in which the user's pupil gazes. According to an embodiment, it is possible to track the trajectory of the user's eyes or gaze using a plurality of first camera modules 251 having the same specifications and performance.

According to an embodiment, the camera modules 250 may include at least one second camera module 253. According to an embodiment, the second camera module 253 may capture an external image. According to an embodiment, the second camera module 253 may capture an external image through the second optical hole 223 formed in the second frame 202b. For example, the second camera module 253 may include a high-resolution color camera, and it may be a high resolution (HR) or photo video (PV) camera. According to an embodiment, the second camera module 253 may provide an auto-focus (AF) function and an optical image stabilizer (OIS) function.

According to an embodiment (not shown), the wearable electronic device 200 may include a flash (not shown) positioned adjacent to the second camera module 253. For example, the flash (not shown) may provide light for increasing brightness (e.g., illuminance) around the wearable electronic device 200 when an external image is obtained by the second camera module 253, thereby reducing difficulty in obtaining an image due to the dark environment, the mixing of various light beams, and/or the reflection of light.

According to an embodiment, the camera modules 250 may include at least one third camera module 255. According to an embodiment, the third camera module 255 may capture the user's motion through a first optical hole 221 formed in the lens frame 202. For example, the third camera module 255 may capture the user's gesture (e.g., hand gesture). Third camera modules 255 and/or first optical holes 221 may be disposed on two opposite sides of the lens frame 202 (e.g., the second frame 202b), e.g., formed in two opposite ends of the lens frame 202 (e.g., the second frame 202b) with respect to the Z direction. According to an embodiment, the third camera module 255 may include a global shutter (GS)-type camera. For example, the third camera module 255 may be a camera supporting 3DoF (degrees of freedom) or 6DoF, which may provide position recognition and/or motion recognition in a 360-degree space (e.g., omni-directionally). According to an embodiment, the third camera modules 255 may be stereo cameras and may perform the functions of simultaneous localization and mapping (SLAM) and user motion recognition using a plurality of global shutter-type cameras with the same specifications and performance. According to an embodiment, the third camera module 255 may include an infrared (IR) camera (e.g., a time of flight (TOF) camera or a structured light camera). For example, the IR camera may operate as at least a portion of a sensor module (e.g., the sensor module 176 of FIG. 1) for detecting distance to a subject.

According to an embodiment, at least one of the first camera module 251 or the third camera module 255 may be replaced with a sensor module (e.g., the sensor module 176 of FIG. 1). For example, the sensor module may include at least one of a vertical cavity surface emitting laser (VCSEL), an infrared sensor, and/or a photodiode. For example, the photodiode may include a positive intrinsic negative (PIN) photodiode or an avalanche photodiode (APD). The photodiode may be interpreted as a photo detector or a photo sensor.

According to an embodiment, at least one of the first camera module 251, the second camera module 253, and the third camera module 255 may include a plurality of camera modules (not shown). For example, the second camera module 253 may include a plurality of lenses (e.g., wide-angle and telephoto lenses) and image sensors and may be disposed on one surface (e.g., a surface facing in the −Y axis) of the electronic device 200. For example, the wearable electronic device 200 may include a plurality of camera modules having different properties (e.g., angle of view) or functions and control to change the angle of view of the camera module based on the user's selection and/or trajectory information. At least one of the plurality of camera modules may be a wide-angle camera and at least another of the plurality of camera modules may form a telephoto camera.

According to an embodiment, the processor (e.g., processor 120 of FIG. 1) may determine the motion of the wearable electronic device 200 and/or the user's motion using information for the wearable electronic device 200 obtained using at least one of a gesture sensor, a gyro sensor, or an acceleration sensor of the sensor module (e.g., the sensor module 176 of FIG. 1) and the user's action (e.g., approach of the user's body to the wearable electronic device 200) obtained using the third camera module 255. According to an embodiment, in addition to the above-described sensor, the wearable electronic device 200 may include a magnetic (geomagnetic) sensor capable of measuring an orientation using a magnetic field and magnetic force lines and/or a hall sensor capable of obtaining motion information (e.g., moving direction or distance) using the strength of a magnetic field. For example, the processor may determine the motion of the electronic device 200 and/or the user's motion based on information obtained from the magnetic (geomagnetic) sensor and/or the hall sensor.

According to an embodiment (not illustrated), the wearable electronic device 200 may perform an input function (e.g., a touch and/or pressure sensing function) capable of interacting with the user. For example, a component configured to perform a touch and/or pressure sensing function (e.g., a touch sensor and/or a pressure sensor) may be disposed in at least a portion of the wearing member 203. The wearable device 200 may control the virtual image output through the display member 201 based on the information obtained through the components. For example, a sensor associated with a touch and/or pressure sensing function may be formed in various types, e.g., a resistive type, a capacitive type, an electro-magnetic (EM) type, or an optical type. According to an embodiment, the component configured to perform the touch and/or pressure sensing function may be identical in whole or part to the configuration of the input module 150 of FIG. 1.

According to an embodiment, the wearable electronic device 200 may including a reinforcing member 260 that is disposed in an inner space of the lens frame 202 and formed to have a higher rigidity than that of the lens frame 202.

According to an embodiment, the electronic device 200 may include a lens structure 273. The lens structure 273 may refract at least a portion of light. For example, the lens structure 273 may be a prescription lens having a designated refractive index. According to an embodiment, at least a portion of the lens structure 273 may be disposed behind (e.g., +Y direction) the display member 201. For example, the lens structure 273 may be positioned between the display member 201 and the user's eye.

According to an embodiment, the housing 210 may include a hinge cover 227 that may conceal a portion of the hinge structure 229. Another part of the hinge structure 229 may be received or hidden between an inner cover 231 and an outer cover 233, which are described below.

According to an embodiment, the wearing member 203 may include the inner cover 231 and the outer cover 233. For example, the inner cover 231 may be, e.g., a cover configured to face the user's body or directly contact the user's body, and may be formed of a material having low thermal conductivity, e.g., a synthetic resin. According to an embodiment, the inner cover 231 may include an inner side surface (e.g., the inner side surface 231c of FIG. 2) facing the user's body. For example, the outer cover 233 may include, e.g., a material (e.g., a metal) capable of at least partially transferring heat and may be coupled to the inner cover 231 to face each other. According to an embodiment, the outer cover 233 may include an outer side surface (e.g., the outer side surface 231d of FIG. 2) opposite to the inner side surface 231c. In an embodiment, at least one of the circuit board 241 or the speaker module 245 may be received in a space separated from the battery 243 in the wearing member 203. In the illustrated embodiment, the inner cover 231 may include a first cover 231a receiving the circuit board 241 and/or the speaker module 245 and a second cover 231b receiving the battery 243, and the outer cover 233 may include a third cover 233a coupled to face the first cover 231a and a fourth cover 233b coupled to face the second cover 231b. For example, the first cover 231a and the third cover 233a may be coupled (hereinafter, ‘first cover portions 231a and 233a’) to receive the circuit board 241 and/or the speaker module 245, and the second cover 231b and the fourth cover 233b may be coupled (hereinafter, ‘second cover portions 231b and 233b’) to receive the battery 243.

According to an embodiment, the first cover portion 231a and the third cover 233a may be rotatably coupled to the lens frame 202 through the hinge structure 229, and the second cover portion 231b and the fourth cover 233b may be connected or mounted to the ends of the first cover portions 231a and 233a through the connecting structure 235. According to an embodiment, a portion of the connecting structure 235 in contact with the user's body may be formed of a material having low thermal conductivity, e.g., an elastic material, such as silicone, polyurethane, or rubber, and another portion thereof which does not come into contact with the user's body may be formed of a material having high thermal conductivity (e.g., a metal). For example, when heat is generated from the circuit board 241 or the battery 243, the connecting structure 235 may block heat transfer to the portion in contact with the user's body while dissipating or discharging heat through the portion not in contact with the user's body. According to an embodiment, a portion of the connecting structure 235 implemented to come into contact with the user's body may be interpreted as a portion of the inner cover 231, and a portion of the connecting structure 235 that does not come into contact with the user's body may be interpreted as a portion of the outer cover 233. According to an embodiment (not shown), the first cover 231a and the second cover 231b may be integrally formed without the connecting structure 235, and the third cover 233a and the fourth cover 233b may be integrally formed without the connecting structure 235. According to an embodiment, other components (e.g., the antenna module 197 of FIG. 1) may be further included in addition to the illustrated components, and information regarding an object or environment may be received from an external electronic device (e.g., the electronic device 102 or 104 of FIG. 1 or the server 108 of FIG. 1) through a network (e.g., the first network 198 or second network 199 of FIG. 1) using a communication module (e.g., the communication module 190 of FIG. 1).

According to an embodiment, the lens frame 202 may include a connection portion 274 disposed between the first display member 201a and the second display member 201b. For example, the connection portion 274 may be interpreted as a portion corresponding to the nose support of the glasses.

According to an embodiment, the electronic device 200 may include a connection member 205. According to an embodiment, the circuit board 241 may be connected to the connection member 205 and transfer electrical signals to the components of the electronic device 200 (e.g., the light output module 211 and/or the camera module 250) through the connection member 205. For example, the control signal transferred from a processor (e.g., the processor 120 of FIG. 1) positioned on the circuit board 241 may be transferred to electronic components by at least a portion of the connection member 205. For example, at least a portion of the connection member 205 may include a line (not shown) electrically connected to components of the electronic device 200.

According to an embodiment, the connection member 205 may include a first connection member 205a at least partially disposed in the first wearing member 203a and a second connection member 205b at least partially disposed in the second wearing member 203b. According to an embodiment, at least a portion of the first connection member 205a and/or the second connection member 205b may face the hinge structure 229. For example, the first connection member 205a may extend from the first circuit board 241a to the inside of the lens frame 202 across the hinge structure 229. The second connection member 205b may extend from the second circuit board 241b to the inside of the lens frame 202 across the hinge structure 229. For example, a portion of the first connection member 205a and a portion of the second connection member 205b may be disposed in the wearing member 203, and another portion may be disposed in the lens frame 202.

According to an embodiment, the first connection member 205a and the second connection member 205b may include a structure that may be folded or unfolded based on rotation of the hinge structure 229. For example, the first connection member 205a and/or the second connection member 205b may include a flexible printed circuit board (FPCB). According to an embodiment, the first connection member 205a may be electrically and/or mechanically connected to the first circuit board 241a. According to an embodiment, the second connection member 205b may be electrically and/or mechanically connected to the second circuit board 241b. According to an embodiment, the first connection member 205a and/or the second connection member 205b may include a structure (e.g., a line and/or cable) for transferring signals.

According to an embodiment, the sensor module 280 (e.g., the sensor module 176 of FIG. 1) may detect the light that has passed through the display member 201. According to an embodiment, the sensor module 280 may include a first sensor module 281 capable of detecting the light passed through the first display member 201a and a second sensor module 282 capable detecting the light passed through the second display member 201b. For example, the first sensor module 281 may detect light from behind the first display member 201a (e.g., +Y direction), and the second sensor module 282 may detect light from behind the second display member 201b. According to an embodiment, the sensor module 280 may include a third sensor module 283 capable of detecting light in front of the display member 201 (e.g., −Y direction). For example, the third sensor module 283 may detect light in front of the display member 201 (e.g., −Y direction). According to an embodiment, the sensor module 280 may be an illuminance sensor. According to an embodiment, the third sensor module 283 may have the same configuration in whole or part as the configuration of the second camera module 253.

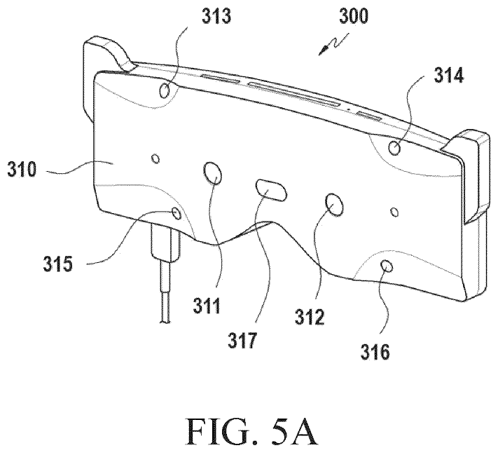

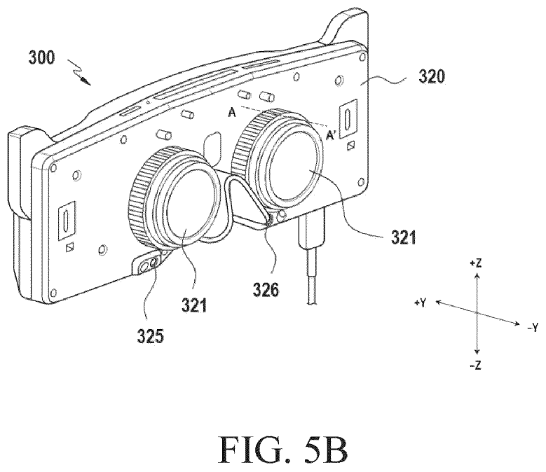

FIG. 5A is a front view illustrating a wearable electronic device according to an embodiment of the disclosure. FIG. 5B is a rear view illustrating a wearable electronic device according to an embodiment of the disclosure.

As an embodiment, the wearable electronic device 300 may be AR glasses or video see-through (VST) type VR glasses. In an embodiment, the VST-type VR glasses may capture the external environment by a camera (not shown) and display the captured external environment image, along with VR content, to the user through the display 321 (and/or lens). For example, the VR content may be content, such as navigation or data related to a specific object.

Referring to FIGS. 5A and 5B, in an embodiment, camera modules 311, 312, 313, 314, 315, and 316 and/or a depth sensor 317 for obtaining information related to the ambient environment of the wearable electronic device 300 may be disposed on the first surface 310 of the housing.

In an embodiment, the camera modules 311 and 312 may obtain images related to the ambient environment of the wearable electronic device.

In an embodiment, the camera modules 313, 314, 315, and 316 may obtain images while the wearable electronic device is worn by the user. The camera modules 313, 314, 315, and 316 may be used for hand detection, tracking, and recognition of the user gesture (e.g., hand motion). The camera modules 313, 314, 315, and 316 may be used for 3 degrees of freedom (DoF) or 6DoF head tracking, location (space or environment) recognition, and/or movement recognition. In an embodiment, the camera modules 311 and 312 may be used for hand detection and tracking and recognition of the user's gesture.

In an embodiment, the depth sensor 317 may be configured to transmit a signal and receive a signal reflected from an object and be used for identifying the distance to the object, such as time of flight (TOF).

According to an embodiment, camera modules 325 and 326 for face recognition and/or a display 321 (and/or lens) may be disposed on the second surface 320 of the housing.

In an embodiment, the face recognition camera modules 325 and 326 adjacent to the display may be used for recognizing the user's face or may recognize and/or track both eyes of the user.

In an embodiment, the display 321 (and/or lens) may be disposed on the second surface 320 of the wearable electronic device 300. In an embodiment, the wearable electronic device 300 may not include the camera modules 315 and 316 among the plurality of camera modules 313, 314, 315, and 316. The wearable electronic device 300 may omit at least one of the components shown in FIGS. 5A and 5B or may further include components not shown in the drawings. For example, the wearable electronic device 300 may omit at least one of the camera modules or may include more camera modules.

As described above, according to an embodiment, the wearable electronic device 300 may have a form factor to be worn on the user's head. The wearable electronic device 300 may further include a strap and/or a wearing member to be fixed on the user's body part. The wearable electronic device 300 may provide the user experience based on augmented reality, virtual reality, and/or mixed reality while worn on the user's head.

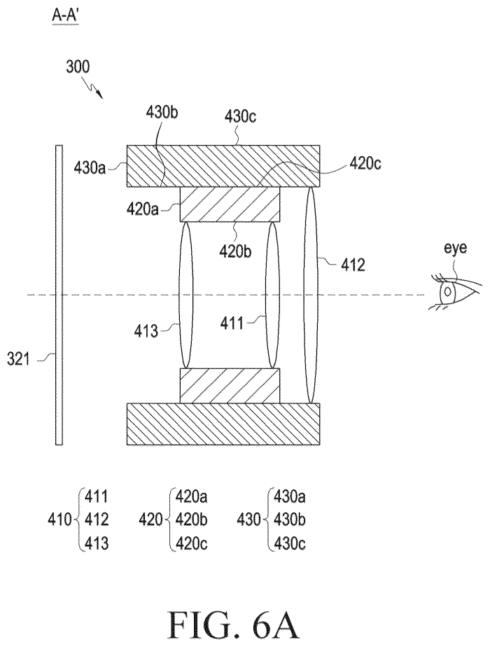

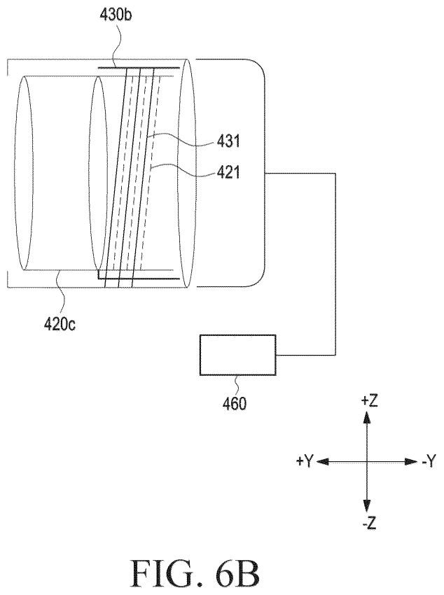

FIG. 6A is a view schematically illustrating a cross-section of the wearable electronic device 300 of FIG. 5B taken along line A-A′ according to an embodiment of the disclosure. FIG. 6B is a view schematically illustrating a wearable electronic device including a motor according to an embodiment of the disclosure.

Referring to FIGS. 6A and 6B, the wearable electronic device 300 may include a lens assembly 410 and barrels 420 and 430. The configuration of the lens assembly 410 of FIGS. 6A and 6B may be identical in whole or part to the configuration of the display (and/or lens) 321 of FIGS. 2 to 5B. The structure of FIGS. 6A and 6B may be selectively combinable with the structure of FIGS. 2 to 5B.

According to an embodiment, the wearable electronic device 300 may be, e.g., a head-mounted display (HMD) apparatus. The head-mounted display (HMD) apparatus 300 may be mounted on a predetermined portion of the body, e.g., the head, to display an image. For example, the wearable electronic device 300 may be formed in a goggle shape or a glasses shape. The wearable electronic device 300 may have a display positioned at a location facing the user's eyes to output an image.

According to an embodiment, the wearable electronic device 300 may include a housing (e.g., the second surface 320 of FIG. 5B), a lens assembly 410 positioned between the user and the display for correcting the user's vision, and barrels 420 and 430 coupled to the housing and configured to surround the lens assembly 410.

According to an embodiment, an image output from the display may be provided to the user through the lens assembly 410. The lens assembly 410 may adjust focus so that a screen output from the display may be seen by the user's eyes. The lens assembly 410 may be composed of a plurality of lenses. The plurality of lenses constituting the lens assembly 410 may include lenses such as, e.g., a Fresnel lens, a Pancake lens, or a multi-channel lens. The lens assembly 410 may include a left lens corresponding to the user's left eye and a right lens corresponding to the user's right eye. Hereinafter, for convenience of description, either the left lens or the right lens is described. However, this may be equally applicable to the other one.

According to an embodiment, the barrels 420 and 430 may be a component for surrounding the lens assembly 410 and protecting the lens assembly 410 from external impact or external foreign objects. The barrel 420 may be configured to adjust the position of the lens.

According to an embodiment, there may be a plurality of barrels 420 and 430. According to an embodiment, the barrels 420 and 430 may include a first barrel 420 configured to surround the lens assembly 410 and a second barrel 430 surrounding the first barrel 420. For example, the barrel may have a double barrel structure of the first barrel 420 positioned inside and the second barrel 430 positioned outside the first barrel 420. For example, the first barrel 420 may be positioned inside the second barrel 430, and the second barrel 430 may be positioned outside the first barrel 420. The diameter of the first barrel 420 may be smaller than the diameter of the second barrel 430. According to an embodiment, the first barrel 420 may be coupled with at least one lens 411, 413 of the lens assembly 410, and the second barrel 430 may be coupled with at least one lens 412 of the lens assembly 410. For example, at least one lens 411, 413 of the lens assembly 410 may be attached to the first barrel 420, and at least one lens 412 of the lens assembly 410 may be attached to the second barrel 430. The first barrel 420 is movable in the forward/backward direction (+Y to −Y), and the second barrel 430 may be fixed type or vice versa.

According to an embodiment, one of the first barrel 420 and the second barrel 430 may be movable, and the other may not move. For example, the second barrel 430 on the outside has a fixed position, and the first barrel 420 on the inside may have a variable position. For example, the first barrel 420 may be rotatable in a clockwise or counterclockwise direction. For example, the first barrel 420 may be movable in a front direction (+Y direction) or a rear direction (−Y direction). However, whether the barrel 420 moves and the direction of movement are not limited to the embodiment and may be variously designed and changed. Hereinafter, for convenience of description, the position of the second barrel 430 on the outside may be fixed, and the position of the first barrel 420 on the inside may be configured to be variable. However, a case where the position of the first barrel 420 is fixed and the position of the second barrel 430 is variable is also applicable.

According to an embodiment, the shape of the first barrel 420 viewed in the Y-axis direction may be a donut shape. According to an embodiment, the first barrel 420 may include a 1-1th surface 420 a facing the front direction and surrounding the lens, a 1-2th surface 420 b (e.g., inner surface) substantially perpendicularly contacting the 1-1th surface 420 a and facing an inward direction (e.g., the center direction of the barrel, third direction), and a 1-3th surface 420 c (e.g., outer surface) substantially perpendicularly contacting the 1-1th surface 420a and facing an outward direction (e.g., the direction opposite to the center direction of the barrel, fourth direction). For example, the 1-1th surface 420 a of the first barrel 420 may be in a donut shape. The 1-1th surface 420 a may be a flat surface. For example, the 1-2th surface 420 b and the 1-3th surface 420 c of the first barrel 420 may be curved surfaces. The 1-2th surface 420 b and the 1-3th surface 420 c may substantially perpendicularly contact the housing.

According to an embodiment, the shape of the second barrel 430 viewed in the Y-axis direction may be a donut shape. According to an embodiment, the second barrel 430 may include a 2-1th surface 430 a facing the front direction and surrounding the lens, a 2-2th surface 430 b (e.g., inner surface) substantially perpendicularly contacting the 2-1th surface 430a and facing an inward direction (e.g., the center direction of the barrel, third direction), and a 2-3th surface 430 c (e.g., outer surface) substantially perpendicularly contacting the 2-1th surface 430a and facing an outward direction (e.g., the direction opposite to the center direction of the barrel, fourth direction). For example, the 2-1th surface 430 a of the second barrel 430 may be in a donut shape. The 2-1th surface 430 a may be a flat surface. For example, the 2-2th surface 430 b and the 2-3th surface 430 c of the second barrel 430 may be curved surfaces. The 2-2th surface 430 b and the 2-3th surface 430 c may substantially perpendicularly contact the housing. For example, the 1-3th surface 420 c of the first barrel 420 and the 2-2th surface 430 b of the second barrel 430 may face each other.

According to an embodiment, lenses 411, 412, 413 constituting the lens assembly 410 may contact the first barrel 420 or the second barrel 430. According to an embodiment, the lens assembly 410 may include a third lens 413 fixed to the first barrel 420 and a second lens 412 fixed to the second barrel 430. According to an embodiment, when the first barrel 420 moves, the third lens 413 may move together with the first barrel 420. When the position of the first barrel 420 changes, the position of the third lens 413 may also change correspondingly. When the position of the first barrel 420 moves, diopter adjustment may be possible because the distance between the third lens 413 and the second lens 412 changes. A user may adjust the diopter by moving the position of the first barrel 420. When the focal length of the lens changes by adjusting the diopter and an image is formed on the user's retina, the user may see an accurate screen or object.

According to an embodiment, the lens assembly 410 may further include a first lens 411 contacting a barrel (e.g., the first barrel 420) configured to have a variable position. According to an embodiment, the lens assembly 410 may further include a first lens 411 fixed to the first barrel 420. For example, the first lens 411 may be a liquid crystal (LC) lens. A liquid crystal (LC) lens may be defined as a lens made using liquid crystal. The first lens 411 may have a variable focal length. The first lens 411 may electronically control the focal length without mechanical movement. The wearable electronic device 300 of the disclosure includes the first lens 411 capable of electronically controlling the focal length, enabling fine diopter adjustment electronically as well as physical distance movement. According to an embodiment, when the position of the first barrel 420 moves, the position of the first lens 411 may also move correspondingly. When the position of the first barrel 420 moves, it may affect diopter adjustment because the distance between the first lens 411 and the second lens 412 changes.

According to an embodiment, when the position of the first lens 411 moves, it may be moved to a preset value. Then, in a fine adjustment operation, the diopter may be adjusted using software.

According to an embodiment, the first barrel 420 may include a wheel (not illustrated) for adjusting the diopter of the lens. A wheel positioned on the 1-3th surface 420 c of the first barrel 420 may be formed so that at least a portion is exposed through an opening (not illustrated) formed in the second barrel 430. When the wheel moves in a clockwise or counterclockwise direction, the first barrel 420 rotates in a clockwise or counterclockwise direction to correspond to the movement direction of the wheel, and along with this, the positions of the first barrel 420 and the first lens 411 and/or the third lens 413 fixed to the first barrel 420 may move in a front or rear direction (e.g., −Y direction or +Y direction of FIG. 6). As the positions of the first lens 411 and/or the third lens 413 move in a front or rear direction (e.g., −Y direction or +Y direction of FIG. 6), the diopter of the lens assembly 410 may be adjusted. The user may adjust the diopter by rotating the wheel.

According to an embodiment, referring to FIG. 6B, rotation of the first barrel 420 may be adjusted by the user directly turning it by hand. According to an embodiment, rotation of the first barrel 420 may use a motor 460. When operating the motor 460, the first barrel 420 may rotate and move in a front or rear direction (e.g., −Y direction or +Y direction of FIG. 6B) along threads (e.g., the first thread 421, the second thread 431). According to an embodiment, the motor 460 may be connected to the first barrel 420. For example, the rotation axis of the motor 460 and the first barrel 420 may be electrically connected so that the first barrel 420 rotates when the motor 460 rotates. For example, rotation of the motor 460 may be converted to horizontal movement so that the first barrel 420 moves in a front or rear direction (e.g., −Y direction or +Y direction of FIG. 6).

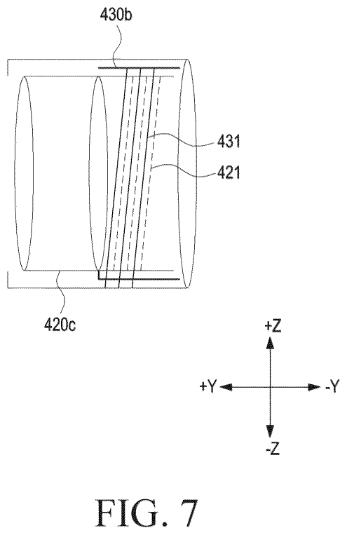

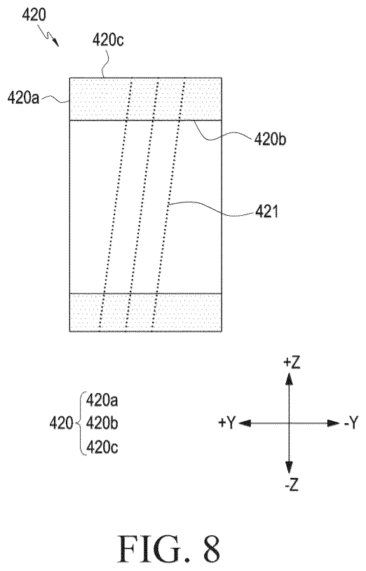

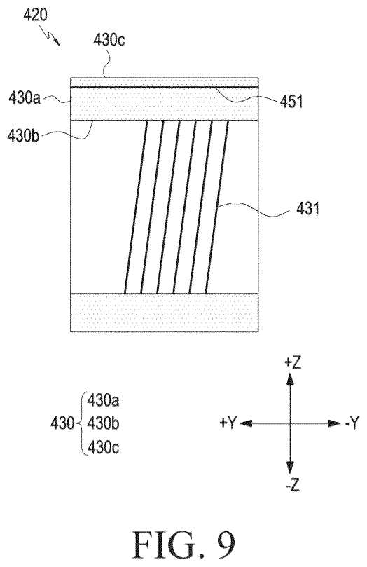

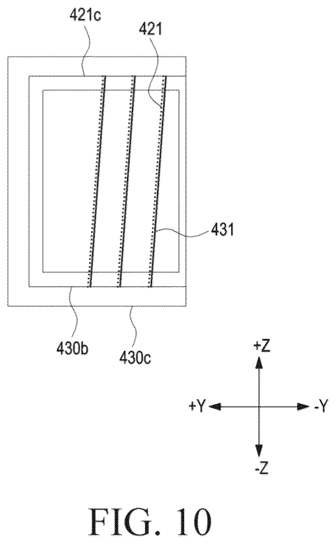

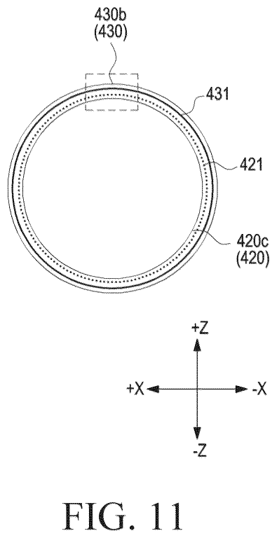

FIG. 7 is a view illustrating a barrel including a thread according to an embodiment of the disclosure. FIG. 8 is a side view illustrating a first thread 421 of a first barrel according to an embodiment of the disclosure. FIG. 9 is a side view illustrating a second thread 431 of a second barrel according to an embodiment of the disclosure. FIG. 10 is a side view illustrating first and second threads of first and second barrels according to an embodiment of the disclosure. FIG. 11 is a view of first and second threads of first and second barrels from a front direction according to an embodiment of the disclosure.

Referring to FIGS. 7 to 11, the wearable electronic device 300 may include a lens assembly 410 and barrels 420 and 430. The configuration of the lens assembly 410 and barrels 420 and 430 of FIGS. 7 to 11 may be identical in whole or part to the configuration of the lens assembly 410 and barrels 420 and 430 of FIG. 6. The structure of FIGS. 7 to 11 may be selectively coupled to the structure of FIG. 6.

According to an embodiment, the first barrel 420 may include a first thread 421. According to an embodiment, the first thread 421 may be disposed on the 1-3th surface 420 c which is the outer surface of the first barrel 420. The first thread 421 may be disposed toward the second barrel 430. The first thread 421 may be in the form of a line extending at a constant angle with respect to the 1-3th surface 420 c of the first barrel 420. According to an embodiment, the first thread 421 may be a conductor. The first thread 421 may be formed of metal. At least a partial region of the first thread 421 may include metal.

According to an embodiment, the second barrel 430 may include a second thread 431. According to an embodiment, the second thread 431 may be disposed on the 2-2th surface 430b which is the inner surface of the second barrel 430. The second thread 431 may be disposed toward the first barrel 420. The second thread 431 may be in the form of a line extending at a constant angle with respect to the 2-2th surface 430 b of the second barrel 430. According to an embodiment, the second thread 431 may be a conductor. The second thread 431 may be formed of metal. At least a partial region of the second thread 431 may include metal. For example, the second thread 431 may be divided into a first region including metal and a second region which is not the first region. According to an embodiment, the cross-section of the first thread 421 may be in a triangular shape. However, the shape of the cross-section of the thread is not limited to the embodiment and may be variously designed and changed. Referring to FIGS. 7 to 11, the first thread 421 is shown with a dashed line, and the second thread 431 is shown with a solid line, but this is merely for convenience of description and is not related to the type or material of the first thread 421 and the second thread 431.

According to an embodiment, the first thread 421 of the first barrel 420 and the second thread 431 of the second barrel 430 may face each other. The shape, arrangement, and degree of inclination of the second thread 431 and the first thread 421 may be substantially the same. According to an embodiment, the first thread 421 and the second thread 431 may contact each other. For example, one surface of the first thread 421 and one surface of the second thread 431 may contact each other.

According to an embodiment, the first barrel 420 may move along the first thread 421. The first barrel 420 may move while rotating along the first thread 421. The first barrel 420 may move along the first thread 421 and/or the second thread 431 with respect to the second barrel 430. One surface of the first thread 421 and one surface of the second thread 431 may move relative to each other while in contact. One surface of the first thread 421 and one surface of the second thread 431 may always be in contact. For example, when the first barrel 420 rotates, the first thread 421 and the second thread 431 may move in contact and rotate along the first thread 421. In this case, the first barrel 420 may rotate and simultaneously move in a front direction (−Y-axis direction) or a rear direction (+Y-axis direction).

According to an embodiment, when using metal for the first thread 421 and the second thread 431, it may be electrically connected to ground (GND) by utilizing a structure in which the first thread 421 and the second thread 431 of the first barrel 420 and the second barrel 430 contact each other. In this case, it should be electrically connected to ground (GND) through the second barrel 430, and by placing metal lines only in part rather than the entire second barrel 430, weight may be reduced compared to plating the entire second barrel 430 with metal.

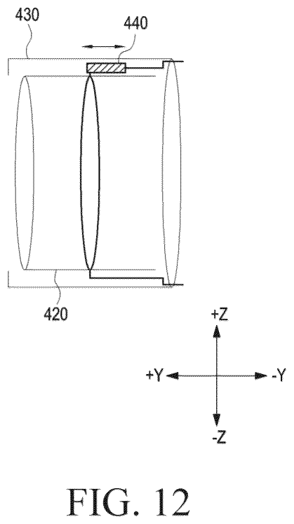

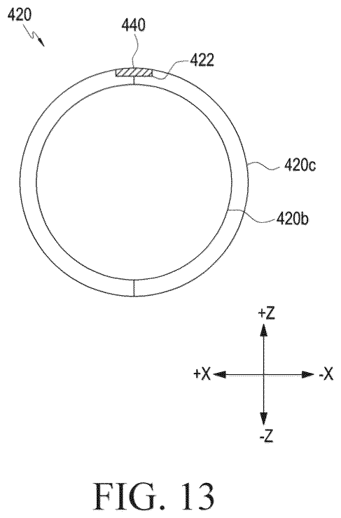

FIG. 12 is a view illustrating a barrel including a sensor member 440 from a side according to an embodiment of the disclosure. FIG. 13 is a view illustrating a barrel including a sensor member 440 from a front according to an embodiment of the disclosure.

Referring to FIGS. 12 to 13, the wearable electronic device 300 may include a lens assembly 410 and barrels 420 and 430. The configuration of the lens assembly 410 and barrels 420 and 430 of FIGS. 12 to 13 may be identical in whole or part to the configuration of the lens assembly 410 and barrels 420 and 430 of FIGS. 6 to 11. The structure of FIGS. 12 to 13 may be selectively coupled to the structure of FIG. 11.

According to an embodiment, a sensor member 440 (inertial measurement unit (IMU)) may be disposed in a barrel with variable position (e.g., the first barrel 420). The sensor member 440 (e.g., an inertial measurement unit (IMU)) may be defined as an inertial measurement device, and may be a sensor-based device that measures the speed, direction, gravity, and acceleration of a moving object.

According to an embodiment, the sensor member 440 may be fixed to the first barrel 420 with variable position. The sensor member 440 may move together with the first barrel 420. The sensor member 440 may measure the rotational speed of the first barrel 420 and the resulting movement distance while moving together with the first barrel 420.

According to an embodiment, the first barrel 420 may include a groove 422 corresponding to the size and shape of the sensor member 440. The 1-3th surface 420 c, which is the outer surface of the first barrel 420, may include a groove 422 recessed in an inward direction. The sensor member 440 may be disposed in the groove 422. However, the method in which the sensor member 440 is disposed and/or fixed in the first barrel 420 is not limited to the embodiment and may be variously designed and changed as long as it does not interfere with the user's optical path.

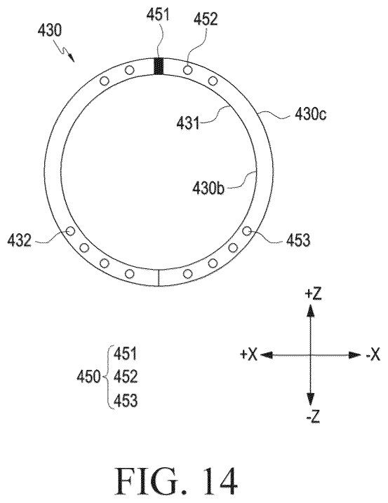

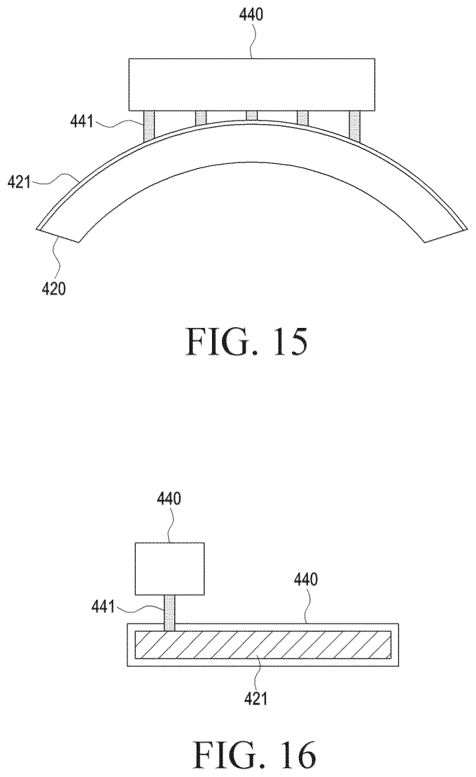

FIG. 14 is a view illustrating a barrel including a plurality of metal lines 450 from a front according to an embodiment of the disclosure. FIG. 15 is a view illustrating a sensor member according to an embodiment of the disclosure. FIG. 16 is a view illustrating a connection relationship between a sensor member and a barrel according to an embodiment of the disclosure.

Referring to FIGS. 14 to 16, the wearable electronic device 300 may include a lens assembly 410 and barrels 420 and 430. The configuration of the lens assembly 410 and barrels 420 and 430 of FIGS. 14 to 16 may be identical in whole or part to the configuration of the lens assembly 410 and barrels 420 and 430 of FIGS. 6 to 13. The structure of FIGS. 14 to 16 may be selectively combinable with the structure of FIGS. 2 to 13.

According to an embodiment, the sensor member 440 and/or the first lens 411 may be electrically connected to a printed circuit board (not illustrated) disposed within the housing. When the sensor member 440 and/or the first lens 411 are disposed in the first barrel 420 configured to be rotatable, spatially and electrically efficient connection may be required.

According to an embodiment, the wearable electronic device 300 may include a plurality of metal lines 450 positioned inside the second barrel 430 and electrically connected to the printed circuit board disposed within the housing.

According to an embodiment, the second barrel 430 may include a plurality of holes 432 recessed in a rear direction (+Y direction) from the 2-1th surface 430 a of the second barrel 430. According to an embodiment, the plurality of metal lines 450 may be disposed within the plurality of holes 432. According to an embodiment, the plurality of metal lines 450 may be lines formed by filling the plurality of holes 432 with metal. The plurality of metal lines 450 may extend in the Y-axis direction from the 2-1th surface 430 a of the second barrel 430 to the inside of the housing of the wearable electronic device 300.

According to an embodiment, the plurality of metal lines 450 may include a first metal line 451 having an end contacting the printed circuit board within the housing. One surface of the first metal line 451 may be exposed to the outside. For example, one surface of the first metal line 451 may be disposed substantially parallel to the 2-3th surface 430 c which is the outer surface of the second barrel 430. One surface of the first metal line 451 may not contact the second barrel 430. According to an embodiment, one surface of the first metal line 451 may contact the second thread 431 disposed on the 2-2th surface 430 b of the second barrel 430. For example, since the second thread 431 is disposed to wrap around the 2-2th surface 430b of the second barrel 430, one surface of the first metal line 451 may contact the second thread 431 in a plurality of regions. According to an embodiment, since the first metal line 451 connected to the printed circuit board contacts the second thread 431, and the second thread 431 contacts the first thread 421, the first thread 421 and/or the second thread 431 may be electrically connected to the printed circuit board.

According to an embodiment, the plurality of metal lines 450 may include a second metal line 452 electrically connected to the sensor member (IMU) 440 fixed to the first barrel 420.

According to an embodiment, the sensor member 440 fixed to the first barrel 420 includes a plurality of metal legs 441, and the plurality of metal legs 441 may be connected to the first thread 421 formed on the first barrel 420.

According to an embodiment, the plurality of metal legs 441 may be variously set according to the distance between the sensor member 440 and the first thread 421. For example, referring to FIG. 15, the plurality of metal legs 441 may be formed such that the length of the metal legs 441 connected to the first thread 421 from the central portion of the sensor member 440 is short, and the length of the metal legs 441 connected to the first thread 421 from the edge portion of the sensor member 440 is relatively longer.

According to an embodiment, the plurality of metal legs 441 connected to the sensor member 440 contact the first thread 421, the first thread 421 contacts the second thread 431, the second thread 431 contacts the second metal line 452, and the second metal line 452 may contact the printed circuit board.

According to an embodiment, the plurality of metal legs 441 connected to the sensor member 440 contact the second thread 431 formed on the second barrel 430, the second thread 431 contacts the second metal line 452, and the second metal line 452 may contact the printed circuit board.

Therefore, even without adding lines directly to the first barrel 420 where the sensor member 440 is disposed and the position is variable, the sensor member 440 and the printed circuit board may be electrically connected. For example, even when the first barrel 420 rotates, the sensor member 440 and the first thread 421 connected to the sensor member 440 move together, and the first thread 421 may always maintain contact with the second thread 431 even when rotating and/or moving, thereby implementing a spatially efficient line structure.

According to an embodiment, the plurality of metal lines 450 may include a third metal line 453 electrically connected to the first lens 411 fixed to the first barrel 420.

According to an embodiment, the first lens 411 fixed to the first barrel 420 may be connected to the first thread 421 formed on the first barrel 420. According to an embodiment, the first lens 411 contacts the first thread 421, the first thread 421 contacts the second thread 431, the second thread 431 contacts the third metal line 453, and the third metal line 453 may contact the printed circuit board. According to an embodiment, the first lens 411 contacts the second thread 431 formed on the second barrel 430, the second thread 431 contacts the third metal line 453, and the third metal line 453 may contact the printed circuit board.

Therefore, even without adding lines directly to the first barrel 420 where the first lens 411 is disposed and the position is variable, the first lens 411 and the printed circuit board may be electrically connected. For example, even when the first barrel 420 rotates, the first lens 411 and the first thread 421 connected to the first lens 411 move together, and the first thread 421 may always maintain contact with the second thread 431 even when rotating and/or moving. According to an embodiment, even when the metal legs 441 move, the signal connection state may be maintained.

Therefore, according to the electronic device of the disclosure, a spatially efficient line structure may be implemented.

An electronic device according to an embodiment of the disclosure may include a housing, a printed circuit board disposed within the housing, a lens assembly 410 including a first lens 411 configured to be movable in a first direction or a second direction opposite to the first direction and being a liquid crystal (LC) lens, a first barrel 420 surrounding the lens assembly, configured to adjust a position of the lens assembly, and including a first thread 421 at least a portion of which is metal, a second barrel 430 surrounding the first barrel and including a second thread 431 at least a portion of which is metal, a plurality of metal lines 450 positioned inside the second barrel, and a processor electrically connected to the printed circuit board and configured to control a refractive index of the first lens by a sensor value of a sensor member (IMU) 440. The plurality of metal lines may include a first metal line 451 electrically connected to the printed circuit board, a second metal line 452 electrically connected to the sensor member (IMU) 440 fixed to the first barrel, and a third metal line 453 electrically connected to the first lens. The third metal line may be configured to be electrically connected to either the first metal line or the second metal line in at least a partial region of the third metal line according to rotation of the first barrel.

According to an embodiment, the first lens may be a LC lens.

According to an embodiment, the first barrel may be configured to be movable, and the second barrel may be fixed in position.

According to an embodiment, the first barrel may include a 1-1th surface 420 a surrounding a lens, a 1-2th surface 420 b perpendicularly contacting the 1-1th surface and facing a third direction which is a center direction of the first barrel, and a 1-3th surface 420 c perpendicularly contacting the 1-1th surface and facing a fourth direction opposite to the third direction, and the second barrel may include a 2-1th surface 430 a surrounding a lens, a 2-2th surface 430 b perpendicularly contacting the 2-1th surface and facing a third direction which is a center direction of the second barrel, and a 2-3th surface 430 c perpendicularly contacting the 2-1th surface and facing a fourth direction opposite to the third direction.

According to an embodiment, the first lens of the lens assembly may be fixed to the first barrel, the lens assembly may further include a second lens 412 fixed to the second barrel and, when the first barrel moves, a distance between the first lens and the second lens may be configured to be adjusted.

According to an embodiment, the first thread may be disposed on the 1-3th surface, and the second thread may be disposed on the 2-2th surface.

According to an embodiment, one surface of the first thread and one surface of the second thread may contact each other.

According to an embodiment, the 1-3th surface of the first barrel may include a groove 422 recessed in the third direction, and the sensor member may be disposed in the groove.

According to an embodiment, the second barrel may include a plurality of holes 432 recessed in a rear direction from the 2-1th surface, and the plurality of metal lines may be disposed within the plurality of holes.

According to an embodiment, one surface of the first metal line may be exposed to the outside of the second barrel.

According to an embodiment, one surface of the first metal line may contact the second thread.

According to an embodiment, the sensor member may include a plurality of metal legs 441, and the plurality of metal legs may contact the first thread.

According to an embodiment, the sensor member may include a plurality of metal legs 441, and the plurality of metal legs may contact the second thread.

According to an embodiment, the second metal line may contact the second thread.

According to an embodiment, the first lens may contact the first thread, and the third metal line may contact the second thread.

According to an embodiment of the disclosure, an electronic device 300 may include a housing, a printed circuit board disposed within the housing, a lens assembly 410 including a first lens 411 configured to be movable in a first direction or a second direction opposite to the first direction, a first barrel surrounding the lens assembly 410, configured to adjust a position of the lens assembly 410, and including a first thread 421 at least a portion of which is metal, a second barrel surrounding the first barrel and including a second thread at least a portion of which is metal, and a plurality of metal lines positioned inside the second barrel. The plurality of metal lines may include a first metal line electrically connected to the printed circuit board and contacting the second thread, a second metal line electrically connected to a sensor member (IMU) fixed to the first barrel, and a third metal line electrically connected to the first lens fixed to the first barrel.

One surface of the first thread and one surface of the second thread may contact each other.

According to an embodiment, the first lens may be a LC lens.

According to an embodiment, the first barrel may be configured to be movable, and the second barrel may be fixed in position.

According to an embodiment, the first barrel may include a 1-1th surface 420 a surrounding a lens, a 1-2th surface 420 b perpendicularly contacting the 1-1th surface and facing a third direction which is a center direction of the first barrel, and a 1-3th surface 420 c perpendicularly contacting the 1-1th surface and facing a fourth direction opposite to the third direction, and the second barrel may include a 2-1th surface 430 a surrounding a lens, a 2-2th surface 430 b perpendicularly contacting the 2-1th surface and facing a third direction which is a center direction of the second barrel, and a 2-3th surface 430 c perpendicularly contacting the 2-1th surface and facing a fourth direction opposite to the third direction.

According to an embodiment, the first lens of the lens assembly may be fixed to the first barrel, the lens assembly may further include a second lens 412 fixed to the second barrel and, when the first barrel moves, a distance between the first lens and the second lens may be configured to be adjusted.

In the case of an electronic device 300 including a lens assembly 410 with a diopter adjustment function, the diopter may be adjusted by a wheel method. For example, when rotating the barrel 420 including the lens assembly 410, the barrel 420 rotates and the lens connected to the barrel 420 moves in left and right directions, thereby changing the focal length. Although the diopter may change according to the degree to which the user rotates the barrel 420, fine adjustment of the diopter may be difficult.

The wearable electronic device 300 of the disclosure includes a liquid crystal (LC) lens capable of electronically controlling the focal length, enabling fine diopter adjustment electronically as well as physical distance movement, thereby complementing a diopter adjustment function that may not be completely adjusted by manual rotation.

The electronic device 300 according to an embodiment of the disclosure may enable electrical connection to the external barrel 430 even when adding a liquid crystal (LC) lens to the internal barrel 420.

Objects of the disclosure are not limited to the foregoing, and other unmentioned objects would be apparent to one of ordinary skill in the art.

Effects obtainable from the disclosure are not limited to the above-mentioned effects, and other effects not mentioned may be apparent to one of ordinary skill in the art.

What is claimed is:

1. An electronic device comprising:
a housing;
a printed circuit board in the housing;
a lens assembly configured to be movable in a first direction or a second direction opposite to the first direction, the lens assembly comprising a first lens which is a liquid crystal (LC) lens;
a first barrel surrounding the lens assembly, the first barrel being configured to adjust a position of the lens assembly, and comprising a first thread, wherein at least a portion of the first thread is metal;
a second barrel surrounding the first barrel, the second barrel comprising a second thread, wherein at least a portion of the second thread is metal;
a plurality of metal lines inside the second barrel; and
a processor electrically connected to the printed circuit board and configured to control a refractive index of the first lens based on a sensor value received from a sensor member,
wherein the plurality of metal lines comprises:
a first metal line electrically connected to the printed circuit board;
a second metal line electrically connected to the sensor member, wherein the sensor member is fixed to the first barrel; and
a third metal line electrically connected to the first lens, and
wherein the third metal line comprises at least one partial region configured to electrically connect to either the first metal line or the second metal line according to a rotation of the first barrel.

2. The electronic device of claim 1, wherein the second thread comprises at least one partial region configured to contact the third metal line, and the at least one partial region of the third metal line contacts the printed circuit board.

3. The electronic device of claim 1, wherein the first barrel is movable, and wherein the second barrel is fixed in position.

4. The electronic device of claim 1, wherein the first barrel comprises:
a 1-1th surface surrounding at least one of the first lens,
a 1-2th surface perpendicularly contacting the 1-1th surface and facing a third direction, the third direction being toward a center of the first barrel, and
a 1-3th surface perpendicularly contacting the 1-1th surface and facing a fourth direction, the fourth direction being opposite to the third direction; and
wherein the second barrel comprises:
a 2-1th surface surrounding a second lens,
a 2-2th surface perpendicularly contacting the 2-1th surface and facing the third direction, and
a 2-3th surface perpendicularly contacting the 2-1th surface and facing the fourth direction.

5. The electronic device of claim 1, wherein the first lens is fixed to the first barrel,
wherein the lens assembly further comprises a second lens fixed to the second barrel, and
wherein based on the first barrel moving, a distance between the first lens and the second lens is adjusted.

6. The electronic device of claim 4, wherein the first thread is disposed on the 1-3th surface, and
wherein the second thread is disposed on the 2-2th surface.

7. The electronic device of claim 1, wherein a surface of the first thread and a surface of the second thread contact each other.

8. The electronic device of claim 4, wherein the 1-3th surface comprises a groove recessed in the third direction, and wherein the sensor member is disposed in the groove.

9. The electronic device of claim 4, wherein the second barrel comprises a plurality of holes recessed in a rear direction from the 2-1th surface, and wherein the plurality of metal lines are disposed within the plurality of holes.

10. The electronic device of claim 9, wherein a surface of the first metal line is exposed to an outside of the second barrel.

11. The electronic device of claim 1, wherein a surface of the first metal line contacts the second thread.

12. The electronic device of claim 1, wherein the sensor member comprises a plurality of metal legs configured to contact the first thread.

13. The electronic device of claim 1, wherein the sensor member comprises a plurality of metal legs configured to contact the second thread.

14. The electronic device of claim 1, wherein the second metal line contacts the second thread.

15. The electronic device of claim 1, wherein the first lens contacts the first thread, and wherein the third metal line contacts the second thread.

16. The electronic device of claim 1, wherein the first barrel comprises:
a 1-1th surface surrounding at least one of the first lens;
a 1-2th surface perpendicularly contacting the 1-1th surface and facing a third direction, the third direction being toward a center of the first barrel; and
a 1-3th surface perpendicularly contacting the 1-1th surface and facing a fourth direction, the fourth direction being opposite to the third direction.

17. The electronic device of claim 1, wherein the second barrel comprises:
a 2-1th surface surrounding a second lens;
a 2-2th surface perpendicularly contacting the 2-1th surface and facing a third direction, the third direction being toward a center of the second barrel; and
a 2-3th surface perpendicularly contacting the 2-1th surface and facing a fourth direction, the fourth direction being opposite to the third direction.

18. The electronic device of claim 1, wherein the sensor member is an Inertial Measurement Unit (IMU), and is configured to measure a rotational speed of the first barrel.

19. An electronic device, comprising:
a housing;
a printed circuit board in the housing;
a lens assembly configured to be movable in a first direction or a second direction opposite to the first direction, the lens assembly comprising a first lens which is a liquid crystal (LC) lens;
a first barrel surrounding the lens assembly, the first barrel being configured to adjust a position of the lens assembly, and comprising:
a first thread, wherein at least a portion of the first thread is metal,
a 1-1th surface surrounding at least one of the first lens;
a 1-2th surface perpendicularly contacting the 1-1th surface and facing a third direction, the third direction being toward a center of the first barrel; and
a 1-3th surface perpendicularly contacting the 1-1th surface and facing a fourth direction, the fourth direction being opposite to the third direction;
a second barrel surrounding the first barrel, the second barrel comprising a second thread, wherein at least a portion of the second thread is metal; and
a processor electrically connected to the printed circuit board and configured to control a refractive index of the first lens based on a sensor value received from a sensor member.

20. The electronic device of claim 19, wherein the second barrel comprises:
a 2-1th surface surrounding a second lens;
a 2-2th surface perpendicularly contacting the 2-1th surface and facing the third direction; and
a 2-3th surface perpendicularly contacting the 2-1th surface and facing the fourth direction.
